(19) United States
(12) Patent Application Publication
(10) Pub. No.: US 2008/0222941 A1
(43) Pub. Date: Sep. 18, 2008

(54) Fishing apparatus

(76) Inventor: Graham Douglas Scrimgeour, Hamilton (NZ)

Correspondence Address: YOUNG & THOMPSON, 209 Madison Street, Suite 500, ALEXANDRIA, VA, 22314, US

(21) Appl. No.: 11/790,692

(22) Filed: Apr. 26, 2007

(30) Foreign Application Priority Data
Apr. 26, 2006 (NZ) 546749

(51) Int. Cl. A01K 97/04; A01K 91/00

(52) U.S. Cl. 43/54.1; 43/4.5

(57) ABSTRACT

A fishing apparatus includes a fishing tackle container having flotation elements and at least one racking member adapted to store a plurality of long-line fishing lines separately.

### FIELD OF THE INVENTION

This invention relates to a fishing apparatus, and in particular, but not exclusively to a compact fishing apparatus suitable for use when canoeing or kayaking.

### BACKGROUND

When fishing from a small boat or canoe it can be difficult to manage a fishing line, particularly a long-line, that is a fishing line having a number of fishing hooks spaced along its length.

Long-lines can be difficult to manage at the best of times, let alone when sitting in the confines of a canoe or a kayak. And yet the use of a canoe or kayak can be an ideal way to lay out a long-line. Canoeing and kayaking have become popular pastimes and a natural progression is to try to use the canoe or kayak for fishing.

However, the space available on a canoe or kayak is limited and the hands of the person on the canoe or kayak are often required for steering and manoeuvring while laying out a long-line. The combination of the difficulty in managing a long-line on a small vessel, while at the same time often requiring your hands free for other jobs, can make the it difficult to fish using a long-line from a canoe or long-line.

### OBJECT

It is therefore an object of the present invention to provide a fishing apparatus which will at least go some way towards overcoming the above mentioned problems, or at least provide the public with a useful choice.

### STATEMENTS OF THE INVENTION

Accordingly, in a first aspect, the invention may broadly be said to consist in a fishing apparatus comprising a fishing tackle container, wherein the container includes floatation means and at least one racking means adapted to store a plurality of long-line fishing trace lines separately.

Preferably the container includes a compartment or compartments for storage of the handle and/or the sinkers.

Preferably the container is at least partly brightly coloured.

Preferably the floatation means is permanently secured to the container or formed as part of the container.

Preferably the racking means is adapted to retain each end of a plurality of trace lines.

Preferably the racking means is adapted to hold a plurality of trace lines relatively taught.

Preferably the fishing apparatus further includes a handle about which a long-line can be wound.

Preferably the handle further includes tethering means adapted to allow the handle to be tethered to the wrist of a user.

Preferably the handle includes at least one clamping means that can be used to clamp the free end of a long-line to prevent unravelling of the long-line from the handle.

Preferably the fishing apparatus further includes a work surface, for example a cutting board.

In a second aspect, the invention may broadly be said to consist in a fishing kit incorporating at least one fishing apparatus as specified herein and a long-line.

Preferably the fishing kit further includes a plurality of trace lines.

Preferably the fishing kit further includes at least one sinker.

In a third aspect, the invention may broadly be said to consist in a method of long-line fishing from a canoe or kayak including the steps of;
retrieving a handle about which a long-line is wound from a fishing tackle container having a floatation means, and attaching the handle to the wrist,
securing a sinker to the long-line,
manoeuvring the canoe or kayak and laying out the long-line whilst periodically retrieving trace lines from the fishing tackle container and securing trace lines to the long line, and
and securing the long-line to the fishing tackle container such that the fishing tackle container acts as a marker buoy.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

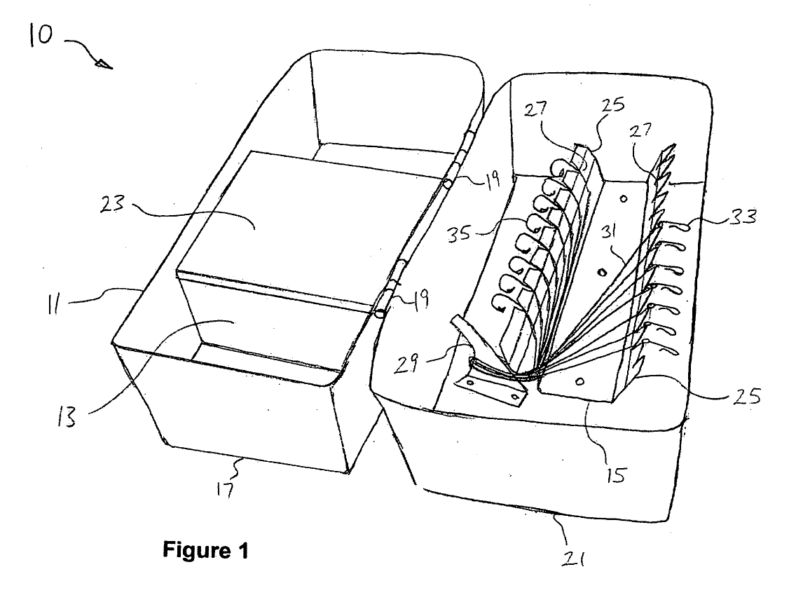

FIG. 1 is a perspective view of a fishing apparatus,

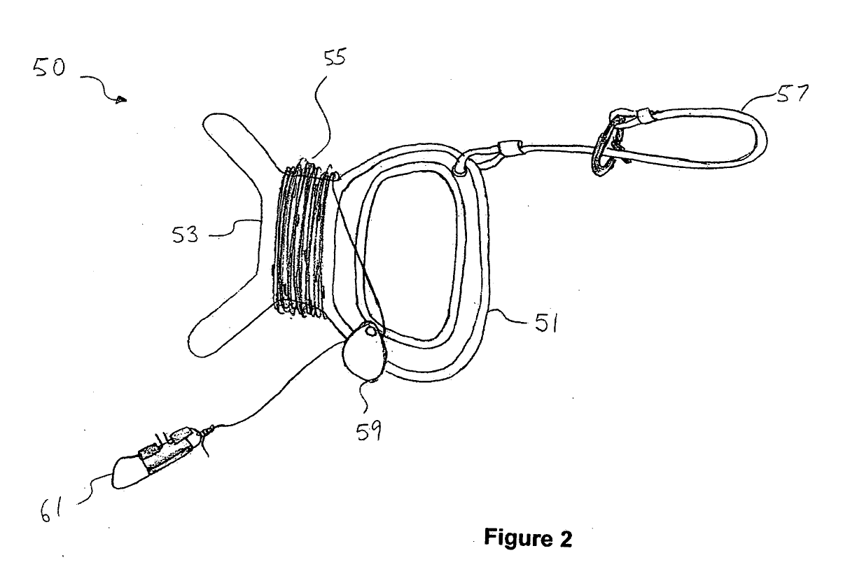

FIG. 2 is a plan view of a long-line handle or winder, and

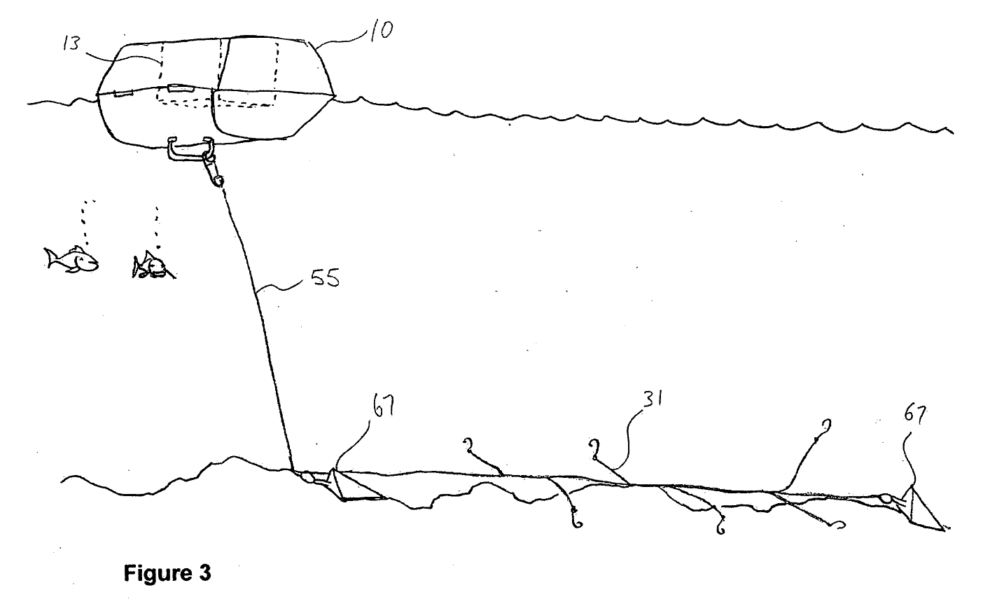

FIG. 3 is an elevation view showing the fishing apparatus in use.

With reference to FIG. 1, a fishing apparatus (10) is shown comprising a container (11) having a float (13) and a rack (15). In this example, the container (11) comprises a base portion (17) which is connected by a pair of hinges (19) to a lid portion (21). In this case both the base and the lid portions (17) and (21) have a similar depth meaning that when the container is opened out fully both portions can rest on a surface making the apparatus (10) relatively stable. The float (13) is shown installed in the base portion (17) and the rack (15) is shown fitted to the lid portion (21).

The upper surface of the float (13) is provided with a work surface (23) which can be used for cutting bait for example.

The float (13) is of sufficient size or buoyancy to be able to keep the apparatus (10) floating well clear of the surface of the water, when the apparatus (10) is placed in water. This is important since one of the functions of the apparatus (10) is to act as a buoy. For this reason also, at least part of the container (11) should be brightly coloured.

In the example shown, the base portion (17) of the container (11) is provided with compartments either side of the float (13). These compartments can be used to store sinkers of a long-line.

The rack (15) includes a length of channel having a substantially “U” shaped cross section, and each flange (25) of the substantially “U” shaped cross section has a series of slots (27) formed along its length. At one end of the rack (15) a short pillar (29) is provided. Each trace line (31) comprises a short length of fishing line with a clip (33) at one end and a fish hook (35) at the other, and these trace lines can be separately mounted on the rack (15) by capturing one end of each trace line in a slot (27) on one flange, then passing the trace line around the pillar (29) then capturing the other end in a slot on the opposing flange of the “U” shaped cross section. In this manner, the trace lines (32) can be installed on the rack (15) in such a way that they are held taught.

With reference to FIG. 2, a long-line handle or winder (50) is shown. The handle (50) includes a hand grip portion (51) and an area (53) about which a long-line (55) can be wound.

The long-line handle (50) also includes a wrist line (57) which can be placed over the wrist of a user, allowing the user to free up his hands quickly for other things without dropping and losing the long-line handle (50).

The long-line handle (50) also includes a clamping means in the form of a clasp (59). In this example, the clasp (59) is attached to, and is biased toward, the hand grip portion (51). The long line (55) can be inserted between the clasp (59) and the hand grip portion (51) to prevent the long-line from unravelling from the long-line handle (50). This is a useful feature especially when the long-line handle (50) is dropped and held only by the wrist line (57) while the user is paddling his canoe or is otherwise engaged.

The free end of the long-line (55) is provided with a clip (61) which can be used to secure a sinker to the long-line.

The long-line handle (50) can be stored in, and be retrieved from the container (11) of the fishing apparatus (10).

With reference to FIG. 3, the fishing apparatus (10) is shown in use. The fishing apparatus (10) is shown in an assembled state with the trace lines (31) and sinkers (67) attached to the long-line (55). The fishing apparatus (10) can be used to help assemble the long-line (55) while the long-line is being laid out by a person manoeuvring a canoe or kayak.

The fishing apparatus (10) can be used to help lay out a long-line from a canoe or kayak, for fishing, as follows;
retrieve a long-line handle (50), about which a long-line (55) is wound, from the container (11) and attach the handle to the wrist using the wrist line (57),
securing a sinker (67) to the long-line (55),
manoeuvre the canoe or kayak and lay out the long-line (55) whilst periodically retrieving trace lines (31) from the container (11) and secure the trace lines (31) to the long line (55), and
securing the long-line (55) to the container (11) such that the container (11) acts as a marker buoy.

The long-line (55) can be retrieved and stowed away in the container (11) by reversing the above steps.

### Variations

In the above example only a single rack (15) is shown, but clearly the fishing apparatus could include more one rack (15), with one or more racks (15) being connected to the container (11) by a hinge.

The floatation means could be a float (13) that is added to the container (11), or alternatively the floatation means could be formed integrally with a part, or parts, the container (11).

Aspects of the present invention have been described by way of example only and it should be appreciated that modifications and additions may be made thereto without departing from the scope thereof.

### Definitions

The term “long-line” used herein is intended to mean a fishing line that can have a number of trace lines attached along its length, each trace line having a fishing hook. Throughout this specification the word “comprise” and variations of that word, such as “comprises” and “comprising”, are not intended to exclude other additives, components, integers or steps.

### Advantages

Thus it can be seen that at least the preferred form of the invention provides a fishing apparatus which can be used to help set out a fishing long-line from a canoe or kayak with a reduced chance of losing or tangling parts of the long-line during the process.

1. A fishing apparatus comprising a fishing tackle container, wherein the container includes floatation means and at least one racking means adapted to store a plurality of long-line fishing trace lines separately.

2. A fishing apparatus as claimed in claim 1, wherein the container includes a compartment or compartments for storage of the handle and/or the sinkers.

3. A fishing apparatus as claimed in claim 1, wherein the container is at least partly brightly coloured.

4. A fishing apparatus as claimed in claim 1, wherein the floatation means is permanently secured to the container or formed as part of the container.

5. A fishing apparatus as claimed in claim 1, wherein the racking means is adapted to retain each end of a plurality of trace lines.

6. A fishing apparatus as claimed in claim 1, wherein the racking means is adapted to hold a plurality of trace lines relatively taught.

7. A fishing apparatus as claimed in claim 1, wherein the fishing apparatus further includes a handle about which a long-line can be wound.

8. A fishing apparatus as claimed in claim 1, wherein the handle further includes tethering means adapted to allow the handle to be tethered to the wrist of a user.

9. A fishing apparatus as claimed in claim 1, wherein the handle includes at least one clamping means that can be used to clamp the free end of a long-line to prevent unravelling of the long-line from the handle.

10. A fishing apparatus as claimed in claim 1, wherein the fishing apparatus further includes a work surface, for example a cutting board.

11. A fishing kit incorporating at least one fishing apparatus as claimed in claim 1 and a long-line.

12. A fishing kit as claimed in claim 11, wherein the fishing kit further includes a plurality of trace lines.

13. A fishing kit as claimed in claim 11, wherein the fishing kit further includes at least one sinker.

14. A method of long-line fishing from a canoe or kayak including the steps of;
retrieving a handle about which a long-line is wound from a fishing tackle container having a floatation means, and attaching the handle to the wrist,
securing a sinker to the long-line,
manoeuvring the canoe or kayak and laying out the long-line whilst periodically retrieving trace lines from the fishing tackle container and securing trace lines to the long line, and
and securing the long-line to the fishing tackle container such that the fishing tackle container acts as a marker buoy.
